(19) United States
(12) Patent Application Publication
(10) Pub. No.: US 2020/0114263 A1
(43) Pub. Date: Apr. 16, 2020

(54) METHODS AND APPARATUS FOR IN-GAME ADVERTISING

(71) Applicant: Red Anchor Trading Corporation, Road Town (VG)

(72) Inventors: Mark Vange, Scottsdale, AZ (US); John Todd Bonner, Highland Beach, FL (US)

(21) Appl. No.: 16/599,034

(22) Filed: Oct. 10, 2019

Related U.S. Application Data
(60) Provisional application No. 62/743,732, filed on Oct. 10, 2018.

(51) Int. Cl. A63F 13/61; G07F 17/32; G06Q 30/02

(52) U.S. Cl. CPC A63F 13/61; A63F 2300/5506; G06Q 30/02; G07F 17/3225

(57) ABSTRACT

Methods and apparatus for an in-game advertising system may comprise a game that comprises one or more adaptable game environment elements and an advertising content system that is configured to store a plurality of advertising elements that can be inserted into the adaptable game environment elements during gameplay. The advertising content system may select which advertising element is inserted into a given adaptable game environment element based on criteria such as unique player information, a type of adaptable game environment element within the game itself, or a pre-defined content type.

### CROSS-REFERENCES TO RELATED APPLICATIONS

This application claims the benefit of U.S. Provisional Patent Application No. 62/743,732, filed Oct. 10, 2018, and incorporates the disclosure of the application by reference.

### BACKGROUND OF THE TECHNOLOGY

Advertising within video games comes in various forms. In some forms gameplay may be paused while an advertisement is presented to the player. Once the advertisement has finished playing, gameplay may be resumed. This type of advertisement is common in games provided to players for free but has an inherent drawback in that players may not actually pay attention to the advertisement decreasing its effectiveness. Other methods of advertising within a video games have traditionally required direct interaction between a game developer and an advertiser to place an advertisement within the gameplay environment that the user is less able to ignore. This approach, however, increases cost and complexity during game development. Further, because this method of providing advertisements is essentially static, the advertisement may not be directed towards appropriate audiences.

### SUMMARY OF THE TECHNOLOGY

Methods and apparatus for an in-game advertising system may comprise a game that comprises one or more adaptable game environment elements and an advertising content system that is configured to store a plurality of advertising elements that can be inserted into the adaptable game environment elements during gameplay. The advertising content system may select which advertising element is inserted into a given adaptable game environment element based on criteria such as unique player information, a type of adaptable game environment element within the game itself, or a pre-defined content type.

### BRIEF DESCRIPTION OF THE DRAWINGS

A more complete understanding of the present technology may be derived by referring to the detailed description and claims when considered in connection with the following illustrative figures. In the following figures, like reference numbers refer to similar elements and steps throughout the figures.

FIG. 1 representatively illustrates an exemplary online computer gaming environment for an in-game advertising system in accordance with an exemplary embodiment of the present technology; and

FIG. 2 representatively illustrates an auditing and tracking system for an in-game advertising system in accordance with an exemplary embodiment of the present technology.

Elements and steps in the figures are illustrated for simplicity and clarity and have not necessarily been rendered according to any particular sequence. For example, steps that may be performed concurrently or in a different order are illustrated in the figures to help to improve understanding of embodiments of the present technology.

### DETAILED DESCRIPTION OF EXEMPLARY EMBODIMENTS

The present technology may be described in terms of functional block components and various processing steps. Such functional blocks may be realized by any number of components configured to perform the specified functions and achieve the various results. For example, the present technology may employ various games, processes, algorithms, servers, engines, clients, platforms, and communication systems. In addition, the technology described is merely one exemplary application for the invention.

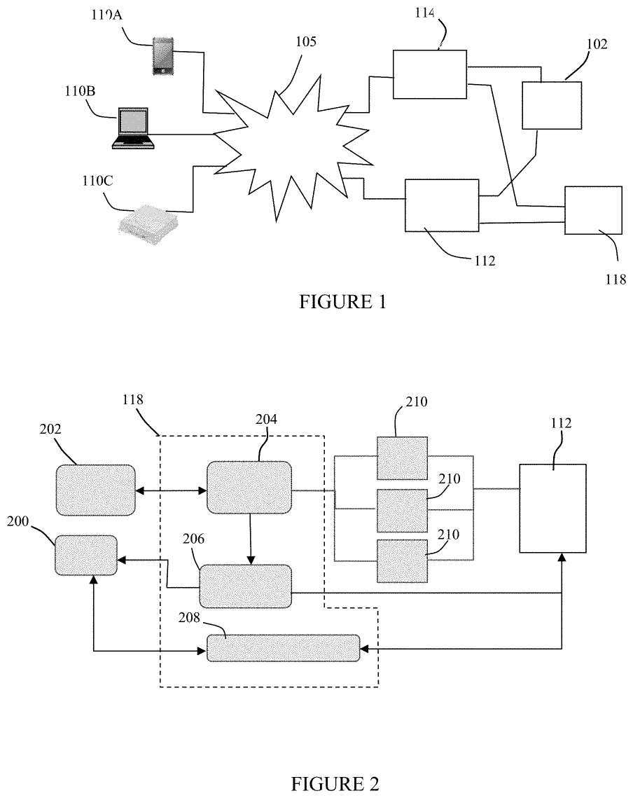

Methods and apparatus for an in-game advertising system according to various aspects of the present technology may operate in conjunction electronically presented content, such as electronic games. Referring to FIG. 1, an exemplary game environment according to various aspects of the present invention may comprise a game infrastructure on a cloud platform. The games and other activities may present in any appropriate form, such as single player games, session-based multiplayer matches, massively multiplayer game worlds, and interactive single-player experiences. In the present exemplary embodiment, the game infrastructure comprises one or more client devices 110, gaming servers 112, game platform service systems 114, game databases 116, and advertising content systems 118.

The client device 110 renders the application for the user. The client device 110 may be any suitable client for interfacing with the user, such as a mobile device 110A like a smartphone or tablet computing device, a personal computer 110B, or a gaming console 110C. The client device 110 may run applications such as games locally, or the applications may run remotely such that the client device 110 operates as a terminal, or applications may run cooperatively between the client device 110 and other systems, such as the client device 110 and a game server 112 operating in a client-server configuration.

The game platform service systems 114 may comprise platform service systems or online service systems that may provide interfaces for meta-game functions, such as Steam, Xbox Live, Google Play Games, or the like. The game platform services 114 may provide any appropriate functions, such as matchmaking, chat, authorization, profile management, and analytics. The game platform services 114 may be implemented as web services, such as microservices for providing fast development cycles and distributed global services.

The game database 116 stores information relating to the game, such as game state, player data, account information, and in-game purchase information. The game database 116 may comprise any appropriate database or multiple databases, such as a relational database, and/or a NoSQL database.

Various embodiments of the gaming environment may include the game servers 112 to provide the game logic to host the games, and may comprise one or more computers in communication with the game clients. To minimize latency, the game client devices 110 may communicate directly with dedicated game servers 112, such as via an Internet 105 connection. Multiple game-server processes may run simultaneously on one machine. Various embodiments of the gaming environment do not include the game servers 112. For example, the games operating on the client devices 110 may speak or interact with advertising content systems 118, such as synchronously or asynchronously. Various embodiments of the gaming environment may include streaming services to allow players to share content with various audiences and to allow audiences to view content as experienced by a participant either in real-time or as a recording at a later time.

In one embodiment, the game servers 112 comprise dedicated game servers, and may comprise multiple game-server processes running simultaneously on a machine. The game server 112 may comprise any suitable game server, such as a real-time simulation, session- or match-based arrangements, massively multiplayer persistent environments, and request/response-based systems. The game servers 112 may be configured for any appropriate parameters, such as minimizing response times, reducing latency, maintaining redundancy, detecting and controlling cheating, and security.

The game servers 112 present games with various sensory elements, such as visual, audio, and tactile components. Various sensory elements of the game may comprise adaptable game environment elements that may be selectively modified during play to display or otherwise provide content for a particular advertiser, such as advertising content received from the advertising content systems 118. For example, the adaptable game environment elements may comprise standardized advertising content surfaces in the game environment. The advertising content surfaces may comprise any appropriate items represented in the game environment, such as billboards, buildings, storefronts, avatar apparel, and interactive items such as weapons, vehicles, equipment, power-ups, food, drink, med-kits, and the like. Adaptable game environment elements may also include advertising activities, such as motion sequences showing a player's avatar or a nonplayer character interacting with the advertising element. For example, in one example the player's avatar may be shown drinking an advertiser's brand of soda or putting on another advertiser's brand of sneakers from a third person perspective.

The game may also use the adaptable game environment elements to provide gameplay elements. For example, using items may confer benefits, such as drinking a particular brand of soft drink to regain health, wearing a particular brand of jeans to enhance charisma, or wearing a hat with an advertiser's logo to acquire “friends” or team members or to show guild affiliation.

In some embodiments, the advertising elements may be rewards. For example, a player achieving a goal might receive an advertiser's brand of candy bar. The candy bar may be depicted in the game as an image of a real candy bar with the advertiser's real-world packaging. The player's avatar may then consume the virtual candy bar, such as in association with a motion sequence of the avatar unwrapping and eating the candy bar, to achieve some benefit like advancing to a new level or acquiring powers.

In addition, the advertising elements may provide opportunities for real world rewards. For example, a player might acquire virtual athletic clothing in the game. The athletic clothing is associated with the player's account, which may then provide coupons, vouchers, or other items of value that may be used outside the gaming environment and in the real world.

The advertising elements may provide real world rewards for in-game actions. In various embodiments, users can hunt for game assets (such as weapons, items, skins etc.) while inside or in the vicinity of real-world stores. For example, game assets can be found via an augmented-reality or virtual-reality style interface on users' mobile devices (analogous to how players located Pokémons on the Pokémon Go app) or other devices which support AR or VR, including but not limited to VR headsets. These game assets, when collected, may also reward players with real-world discounts, including but not limited to coupons offered by the store or stores within the players' vicinity.

In various embodiments, users can hunt for virtual discounts, including but not limited to coupons, while inside or in the vicinity of real-world stores. For example, virtual discounts may be found via an augmented-reality or virtual-reality style interface on users' mobile devices or other devices which support AR or VR, including but not limited to VR headsets. Virtual discounts, when collected, may also reward players with game assets, including but not limited to weapons, items, and skins, and these virtual discounts can be used to redeem real-world discounts offered by the store or stores within the players' vicinity.

In various embodiments, users can hunt for digital tokens (such as HOT Tokens) while inside or in the vicinity of stores. For example, digital tokens may be found via an augmented-reality or virtual-reality style interface on users' mobile devices or other devices which support AR or VR, including but not limited to VR headsets. Digital tokens, when captured, may be used to redeem game assets. Digital tokens, when collected, may also reward players with real-world discounts, including but not limited to coupons offered by the store or stores within the players' vicinity.

In addition, the system may provide in-game rewards for real world actions. In various embodiments, users may be rewarded with game assets (such as weapons, items, skins etc.) or enhanced gaming experience, including but not limited to increased character abilities, special access to game features, and in-game achievements, as a result of real-world actions. For example, a user who buys a can of a particular soft drink in real life may be rewarded with an in-game power-up.

In various embodiments, user data may be transferred from a game to a discount discovery platform or from a discount discovery platform to a game, such as for the purpose of creating targeted advertisements. For example, discount redemption data from a discount discovery platform can be vectored into games to create targeted in-game advertisements based on user data. In addition, advertisement interaction data from games may be vectored into the discount discovery platform to offer targeted discounts to users.

Various embodiments may utilize crypto tokens or digital tokens as a unit of currency earned in the game, such as to redeem an array of reward items or coupons. For example, a HOT token earned in the game may be redeemed for a game item or a real-world coupon.

The game server 112 may implement the advertising elements in any suitable manner. For example, the game server 112 may operate in conjunction with one or more software development kits that allow game designers to develop game environment elements that can be adapted while the game is in progress. For example, the game designer may include a first environmental element comprising a vending machine for getting energy drinks in the game. A basic game element making up the vending machine may not include imagery on the machine, or with default imagery, such as a fictional brand of soft drink. The game server 112 may be designed to select and fetch a fungible advertising element having imagery for vending machines from the advertising content systems 118 while the game is in progress and apply the imagery corresponding to a particular advertiser to the vending machine. As a result, the vending machine may advertise and offer Brand A cola for a week, and then offer Brand B cola the next week. Alternatively, advertising content systems 118 may apply advertising elements having imagery that is more targeted to a particular user based on that user's known preferences. In this way advertisers may be able to direct advertising elements to particular users to strengthen known preferences or to expose those users to new products. The advertising elements may be designed to operate in conjunction with any appropriate game engine, such as Unreal, PS4, Xbox1, and the like.

The advertising content systems 118 provide content to be presented to the user via the advertising elements during the game. The advertising content systems 118 may comprise multiple servers, such as a dedicated advertising content server dedicated to the game and/or a third-party advertising content server that provides content from third parties and accessible by multiple game servers 112 or client devices 110.

The advertising content systems 118 may also serve other functions, such as advertisement counting, selection, and monitoring. The advertising content systems 118 may store and deliver advertising content used in online marketing via the game. The advertising content systems 118 may deliver the advertising content in various digital platforms, such as according to the type of gaming client used by the user and/or the game engine used by the game server 112. The advertising content systems 118 may receive and store the advertising content in a format that is ready to use, such as for use by a particular game engine or game. Alternatively, the advertising content systems 118 may convert advertising content into the relevant format upon receipt from advertiser and/or upon transmission to the game server 112. In some embodiments, the game server 112 may convert the advertising content into the relevant format.

In the present exemplary embodiment, the advertising content systems 118 store and provide content that may be inserted into the play environment of the game during gameplay. Advertisers may provide content to be stored in the advertising content systems 118 and transmission to the game servers 112.

In one embodiment, advertisers may provide content according to pre-defined advertising content types. The pre-defined advertising content types allow the use of standardized advertising content such that games and the advertising content system 118 can accommodate interchangeable advertising content from any advertiser or vendor. Conversely, game developers do not need to insert any particular advertising content, but can instead create advertising opportunities or “spots” within the software for advertising content. For example, advertising content may be developed for a particular platform or environment using standardized mechanisms for the delivery of advertising content, such as including the art and sound content, by providing a software development kit for advertisers and/or developers.

The pre-defined advertising content types may comprise any appropriate types of advertising content. For example, a first pre-defined advertising content type may include passive impression content comprising image or objects inserted into game without significant interaction beyond viewability. In one example, a passive impression content may include a billboard, a store shelf, an open page of a magazine, or other passive type of advertising space commonly existing in the real-world but present in the game-world. Passive impression content performance can be measured by the advertising content systems 118, such as by tracking and storing time on-screen and exposure to users.

A second pre-defined advertising content type may also include a product as a virtual reward, wherein the product is a target of desire and success. For example, the product may be provided when the user achieves a score or objective to earn the product or corresponding virtual object in-game.

A third pre-defined advertising content type may also include a product as an item of action, such as to use the product to achieve a goal in-game. For example, the user may be tasked with finding a particular brand of soft drink as an objective. In addition, the pre-defined advertising content types may facilitate using a product to improve performance within the game itself, such as acquiring a particular brand of jeans, sneakers, or mobile phone to get more friends in game.

Another pre-defined advertising content types may include the product as a power-up, wherein the product may be used to add abilities. For example, a brand of soft drink that refreshes may increase health, a brand of fuel may increase top speed, and/or a brand of convenience store may provide a variety of unique supplies.

Further, the pre-defined advertising content types may include a product as a real-world reward. For example, collection of a virtual products may provide the user with entitlements, discounts, and/or coupons on real-world products.

The advertising content systems 118 may store content for different classes of advertising elements. For example, the advertising content systems 118 may store advertising content from multiple advertisers for use on virtual billboards, and sets of advertising content for use on virtual soft drink cans, food packages, storefronts, watches, pants, shirts, hats, etc. The advertisers may also provide criteria, preferences, and/or restrictions regarding the in-game use of the content. For example, an advertiser may prohibit use of their content in conjunction with weapons, or note a preference for use by female avatars, or place age restrictions on which users the advertising content may be shown. The advertising content systems 118 may also provide information to the advertisers, such as to notify the advertiser that a particular account has earned certain rewards to be provided by the advertiser, as well as analytics and other information relating to the advertising content and the advertiser's campaigns.

The advertising content systems 118 may develop a set of player information for players of the game, such as by directly collecting the information, purchasing such information from third parties, and/or inferring the information based on user indications, such as type of games played, user actions within the game, location, speed of use, commuting patterns, and other inferential vectors. This player information may be stored for individual players or groups of players to allow the advertising content systems 118 to select the appropriate advertising content for the player. For example, a set of player information for a first player may include a data profile that is unique to that first player while the data profile for a second player is unique to that player. Each player profile may be used by the advertising content systems 118 to select individual fungible advertising elements that are specific to a given player.

The advertising content systems 118 may also use environmental indicators, such as the current location of the player, proximity of the player to an advertiser, the time of day, the weather, and many other indications to infer information about the player or to select the most appropriate content to display at any given time.

In addition or alternatively, the advertising content systems 118 may provide advertisers with the opportunity to specify or select particular demographic, geographic, psychographic, environmental, or other parameters as contributors to the ad selection process, such as alone or in conjunction with a relative pricing mechanism that would reflect the advertiser's preference for one set of parameters over another. In some embodiments, the advertising content system 118 may provide an opportunity for advertisers to bid on such advertising capacity based on expressing their preference for one set of parameters over another.

Ad selection may also be performed by examining the historical usage and preference records associated with a particular user, a group or cohort of users, or demographically, geographically, or economically (and other similar attributes) selected groups of users over a set time or over the entire historical record of such user or subset of users.

In some embodiments, the advertising content systems 118 may be configured to select an advertising element based on a set of criteria associated with the adaptable game environment elements. For example, a game developer may create descriptions directed towards what would be an appropriate advertising element for a given adaptable game environment element. Similarly, advertisers may be able to define criteria for advertising elements, which may include descriptions of the advertising elements in the games such as a desired cost for ad placement, desired location, player demographics, date, time, or the like. The developer descriptions and advertiser criteria may be supplied to the advertising content systems 118 which may then automatically match the available adaptable game environment elements within the game to stored advertising elements submitted by the developers and automatically deliver the selected advertising elements to the relevant game server 112 or client device 110.

Referring now to FIG. 2, in addition, the advertising content systems 118 may be configured to provide auditing and/or reporting functions such that the advertising content systems 118 may track and/or report various information relating to the advertising content back to an advertiser 200. For example, the advertising content systems 118 may comprise a measurement tool 206 that is in communication with the game server 112 and the advertiser 200 to track viewership, such as how many people saw an ad; interaction, such as how many people interacted with an ad, for example clicks, fly-throughs, and the like; in-game performance, such as how many people used a virtual item; and/or real-world performance, such as how many people used an item outside the game. An ad server 204 may also be used to obtain data from an analytics source 202 and provide that data to the measurement tool 206 to assist with analyzing the collected data.

The advertising content system 118 may include an auditing system 208 that is in communication with the advertiser 200 and the game server 112. For example, the game server 112 or the advertising content system 118 may include a monitoring process that tracks various information, such as how long an ad-object was on the screen during gameplay, how large it was, how well illuminated it was, length of time of player interaction with ad object, system information (such as was the device “put down” when the ad object was visible) and the like. The ad server 204 may also be in communication with one or more software development kits 210 to insert the selected advertising elements into the appropriate adaptable game environment element within the game.

The advertising content system may select advertising appropriate for streaming services based on user input or based on detection of the presence of streaming software. Streaming focused advertising may further make rewards such as coupons or tokens available to viewers of the content as well as to the participant.

As used herein, the terms “comprises”, “comprising”, or any variation thereof, are intended to reference a non-exclusive inclusion, such that a process, method, article, composition or apparatus that comprises a list of elements does not include only those elements recited, but may also include other elements not expressly listed or inherent to such process, method, article, composition or apparatus. Other combinations and/or modifications of the above-described structures, arrangements, applications, proportions, elements, materials or components used in the practice of the present technology, in addition to those not specifically recited, may be varied or otherwise particularly adapted to specific environments, manufacturing specifications, design parameters or other operating requirements without departing from the general principles of the same.

The present technology has been described above with reference to exemplary embodiments. However, changes and modifications may be made to the exemplary embodiments without departing from the scope of the present technology. These and other changes or modifications are intended to be included within the scope of the present technology, as expressed in the following claims.

1. An in-game advertising system for presenting ads during gameplay on a client device, comprising:
a game server having a game engine, wherein the game server is configured to communicate with the client device;
a game configured to operate with the game server, wherein the game comprises a plurality of adaptable game environment elements within a gameplay environment;
an advertising content system communicatively linked to the game server and configured to:
store a plurality of advertising elements;
select an individual advertising element from the plurality of advertising elements for insertion into an individual adaptable game environment element and displayed on the client device during gameplay.

2. An in-game advertising system according to claim 1, wherein each adaptable game environment element comprises at least one of a passive game element, an interactive game element, a gameplay element, a reward, and a motion sequence.

3. An in-game advertising system according to claim 1, wherein the advertising content system selects the individual advertising element according to a set of player information corresponding to each individual player.

4. An in-game advertising system according to claim 1, wherein the advertising content system selects the individual advertising element according to a set of environmental indicators corresponding to each individual client device's current location.

5. An in-game advertising system according to claim 1, wherein the advertising content system selects the individual advertising element according to a set of criteria associated with the adaptable game environment elements.

6. An in-game advertising system according to claim 1, wherein the advertising content system selects the individual advertising element according to a pre-defined content type.

7. An in-game advertising system according to claim 6, wherein the pre-defined content type comprises at least one of a passive impression content, a product as a virtual reward, a product as an item of action, product as a power-up, and product as a real-world reward.

8. An in-game advertising system according to claim 7, wherein the real-world reward comprises a digital token.

9. An in-game advertising system according to claim 1, wherein the advertising content system:
receives developer descriptions of the adaptable game environment elements;
automatically selects an individual advertising element from the plurality of advertising elements by matching developer descriptions to available advertising elements; and
delivers the selected individual advertising element to the game server.

10. An in-game advertising system according to claim 1, wherein the advertising content system is further configured to provide auditing functions to track and report information relating to the selected individual advertising elements displayed to the client device.

11. An in-game advertising system according to claim 1, wherein the game server converts the selected individual advertising element into a format used by the game engine.

12. An in-game advertising system according to claim 1, wherein advertising content system converts the selected individual advertising element into a format used by the game engine prior to delivering the selected individual advertising element to the game server.

13. A method for in-game advertising to a game player, comprising:
providing a game for use by a client device via a game server, wherein the game comprises a plurality of adaptable game environment elements within a gameplay environment;
selecting an individual advertising element from a plurality of advertising elements stored in an advertising content system communicatively linked to the game server; and
inserting the selected individual advertising element into one of the adaptable game environment elements during gameplay for display on the client device.

14. A method for in-game advertising according to claim 13, further comprising:
receiving with the advertising content system a set of developer descriptions of the adaptable game environment elements;
automatically selecting the individual advertising element from the plurality of advertising elements by matching the set of developer descriptions to available advertising elements; and
delivering the selected individual advertising element to the game server for insertion into one of the adaptable game environment elements.

15. A method for in-game advertising according to claim 13, further comprising providing an auditing function by the advertising content system to track and report information relating to the selected individual advertising element displayed to the client device.

16. A method for in-game advertising according to claim 13, wherein the game server converts the selected individual advertising element into a format used by the game engine.

17. A method for in-game advertising according to claim 13, wherein advertising content system converts the selected individual advertising element into a format used by the game engine prior to delivering the selected individual advertising element to the game server.

18. A method for in-game advertising according to claim 13, wherein each adaptable game environment element comprises at least one of a passive game element, an interactive game element, a gameplay element, a reward, and a motion sequence.

19. A method for in-game advertising according to claim 13, wherein selecting an individual advertising element from a plurality of advertising element comprises selecting the individual advertising element according to a set of player information corresponding to the game player using the client device during gameplay.

20. An in-game advertising system according to claim 13, wherein the advertising content system selects the individual advertising element according to a pre-defined content type comprising at least one of a passive impression content, a product as a virtual reward, a product as an item of action, product as a power-up, and product as a real-world reward.
